(19) United States
(12) Patent Application Publication
(10) Pub. No.: US 2006/0053992 A1
(43) Pub. Date: Mar. 16, 2006

(54) Variable angle miter box

(76) Inventors: Dennis J. Williams, Simpsonville, SC (US); Robert J. Sheil, Taylors, SC (US)

Correspondence Address: Joseph Guy;NEXSEN PRUET ADAMS KLEEMEIER LLC, P.O. Box 10107, Greenville, SC, 29603, US

(21) Appl. No.: 10/938,362

(22) Filed: Sep. 10, 2004

(51) Int. Cl. B23D 15/00

(52) U.S. Cl. 83/435.12; 83/468.3

(57) ABSTRACT

An adjustable miter box with a base plate comprising a blade kerf. A first guide plate is pivotally attached to the base plate. A second guide plate is pivotally attached to the base plate wherein the blade kerf extends between the first guide plate and the second guide plate. Each guide plate guide plate has a fixed fence and an adjustable fence wherein the adjustable fence is slidably attached to the guide plate such that the distance between the fixed fence and the adjustable fence is adjustable and wherein the fixed fence and the adjustable fence remain parallel.

### BACKGROUND OF THE INVENTION

The present invention is directed to a variable angle miter box. More specifically, the present invention is directed to a variable angle miter box capable of insuring accurate cuts on complex angles particularly with a radial arm saw or miter saw.

Cuts involving complex angles, such as those required with crown molding, have long been considered difficult in the art. Crown molding, typically placed on the diagonal between a wall and a ceiling, is particularly difficult to cut correctly. The difficulty is exasperated by the fact that walls are rarely perpendicular with each other or with the ceiling. At ceiling corners, for example, crown molding pieces must accurately meet in the corner yet the angle between mating walls and the angle between the ceiling and each wall varies at each construction site and at each corner. The problem is difficult enough when right angles between walls and ceilings are attempted. When purposefully odd, or non-perpendicular, angles are encountered the difficulties accumulate.

There have been many attempts to develop a simple method for measuring and cutting such angles yet they all are lacking in one way or another.

Dimarco, in U.S. Pat. No. 5,473,821 describes a saw with individually pivoting guide blocks which are set with a parallelogram. The stock, or wood to be cut, is then held against the guide block and cut with the saw. A matching piece is cut on the opposing side. This device is useful yet the problem still arises with compound angles as typically encountered with crown molding. The accuracy of the cut is limited by the inconsistency associated with maintaining the stock at the proper angle relative to the guide block.

James, et al., in U.S. Pat. No. 3,830,127 describes a saw comprising duplicative blades and guide blocks with coordinated rotation mounted on a slide for moving the entire assembly through the duplicative blades. The device of James et al. requires redundant blades and movement of the entire apparatus which is undesirable. It is most preferred that the miter box be used with conventional radial arm and miter saws wherein the miter box is removably fixed to the table of the saw and the saw blade moves in accordance with the normal operation of a radial arm or miter saw.

In spite of the improvements there is still a need for an adjustable miter box which can quickly and accurately cut complex angles with minimal set up, no requirement for alteration of existing saws, and which is economical. Such a device, and method of use, is provided by the present invention.

### SUMMARY OF THE INVENTION

It is an object of the present invention to provide an adjustable miter box which can quickly and easily provide consist accurate cuts of stock.

It is another object of the present invention to provide an adjustable miter box which can be used with conventional radial arm or miter saws without alteration of the saw.

A particular feature of the present invention is the ease with which the present invention could be reversibly incorporated into the table of a radial arm or miter saw with minimal alteration.

Another particular feature of the present invention is the simplicity of design and the low cost with which the apparatus could be manufactured.

An advantage of the present invention is the ability to accurately duplicate any angle with minimal effort.

These and other advantages, as will be realized, are provided in an adjustable miter box. The adjustable miter box has a planar base plate with a rear edge and a front edge. A blade kerf extends from the rear edge toward the front edge. A first guide plate is pivotally attached to the base plate. A second guide plate is pivotally attached to the base plate wherein the blade kerf extends between the first guide plate and the second guide plate. Each of the first guide plate and the second guide plate has a fixed fence and an adjustable fence wherein the adjustable fence is slidably attached to the guide plate such that the distance between the fixed fence and the adjustable fence is adjustable and wherein the fixed fence and the adjustable fence remain parallel.

Yet another embodiment is provided in a method for cutting stock with the steps of:

a) placing stock on a guide plate at a first angle relative to the guide plate and in contact with a fixed fence on the guide plate;

b) sliding an adjustable slide plate on the guide plate into position to maintain the stock at the first angle;

c) pivoting the guide plate to a second angle relative to a blade kerf; and

d) moving a blade into the blade kerf whereby the stock is cut by the blade.

Yet another embodiment is provided in an adjustable miter box with a base plate comprising a blade kerf. A first guide plate is pivotally attached to the base plate. A second guide plate is pivotally attached to the base plate wherein the blade kerf extends between the first guide plate and the second guide plate. Each guide plate guide plate has a fixed fence and an adjustable fence wherein the adjustable fence is slidably attached to the guide plate such that the distance between the fixed fence and the adjustable fence is adjustable and wherein the fixed fence and the adjustable fence remain parallel.

### BRIEF DESCRIPTION OF THE DRAWINGS

FIG. 1 is a rear perspective view of an embodiment of the present invention.

FIG. 2a-c are top views of the embodiment of FIG. 1 wherein the apparatus is adjusted to different angles.

### DETAILED DESCRIPTION OF THE INVENTION

The present invention is specific to an adjustable miter box easily adapatable for use with a radial arm or miter saw and capable of repeatably securing stock for cutting of complex angles. The invention will be described with reference to the various figures which form an integral part of the specification. In the various figures similar elements will be numbered accordingly.

In the Figures, the adjustable miter box, generally represented at 1, comprises a base plate, 2, with a rear edge, 2a, face, 2b, side edges, 2c, and front edge, 2d. The rear edge, 2a, is preferably substantially linear from side edge to side edge to facilitate aligning the device with an existing fence on a radial arm or miter saw as would be realized by one of skill in the art. The base plate, 2, comprises a single blade kerf, 3, preferably perpendicular to the rear edge, 2a, and extending from the rear edge towards the front edge and between the pivots, 5. In operation the blade of the saw would be received by the blade kerf as readily realized by one of skill in the art. The blade kerf is at least deep enough to receive a sufficient amount of the blade to insure a complete cut through the stock such as at least about 1/16 inch. The blade kerf may be cut completely through the base plate and this is preferred.

Pivotally attached to the base plate, 2, and symmetrically placed on either side of the blade kerf is a pair of guide plates, 4. Each guide plate is preferably attached to the base plate by a pivot, 5, and a reversibly engageable arcuate lock mechanism, 6. The reversibly engageable arcuate lock mechanism, 6, preferably comprises a threaded member, 7, and mating nut, 8. The threaded member is preferably received by an arcuate void, 9, in the base plate, 2. When the mating nut is tightly engaged with the guide plate, 4, the angle of the guide plate relative to the kerf is fixed. When the mating nut is not tightly engaged the guide plate can be rotated about the pivot, 5, thereby allowing the angle of the guide plate to be altered with respect to the blade kerf, 3. It is therefore readily ascertainable that each guide plate can be fixed at various angles relative to the blade kerf. The engageable arcuate lock mechanism is defined as a device for reversibly fixing the angle of the guide plate relative to the kerf.

Attached to the top of the guide plate is a fixed fence, 10, and an adjustable fence, 11. The adjustable fence, 11, is slidably attached to the guide plate, 4, such that the distance between the adjustable fence, 11, and fixed fence, 10, is reversibly fixable. The adjustable fence is always parallel to the fixed fence. In a preferred embodiment, the adjustable fence comprises guides, 12, which insure that the adjustable fence stays parallel to the fixed fence. Locks, 13, reversibly secure the adjustable fence at a predetermined distance from the fixed fence. In a preferred embodiment, the locks are threaded members which engage the guide plate to pinch the guide plate between the guide and lock. It would be readily apparent that other guide and lock mechanisms could be employed without departing from the scope of the present invention with the understanding that the guide functions to maintain the adjustable fence in a parallel relationship with the fixed fence while allowing the distance there between to be adjusted and the lock reversibly secures the adjustable fence at the preferred distance.

An optional, but preferred, angular scale, 15, and indicator, 16, provide a guide for the angle of the fixed fence relative to the blade kerf. As would be realized the angle between the adjustable fence and blade kerf is the same as that of the fixed fence and blade kerf.

An optional handle void, 14, is provided to facilitate transport and to provide a convenient mechanism to hang the adjustable miter box for storage.

The method of employing the adjustable miter box will be described with reference to the various figures.

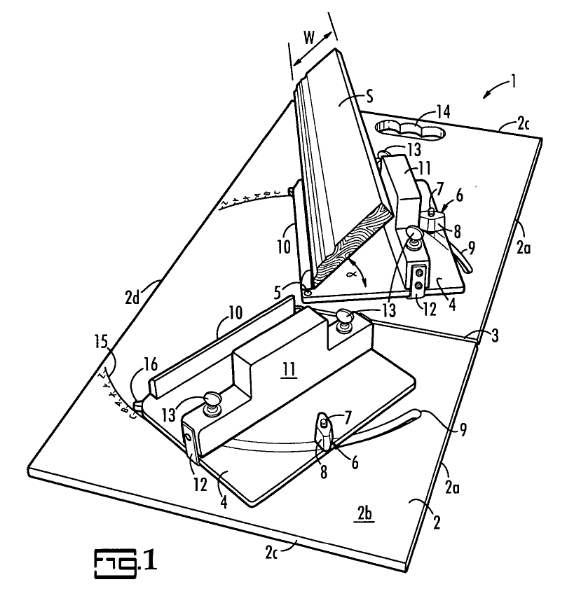

Prior to use, the distance between the adjustable fence and the fixed fence is set. For crown molding, for example, the distance is set such that a piece of stock, S, is at the proper angle relative to the guide plate when resting in contact with the fixed guide and guide plate on one side while being supported by the adjustable slide on the other side. For example, a piece of stock, S, is illustrated in FIG. 1 to be at an angle, α, relative to the guide plate. The distance between the adjustable guide and fixed guide is then maintained as long as the width, W, of the stock, S, is maintained. The distance between each adjustable fence and fixed fence should be the same as would be realized.

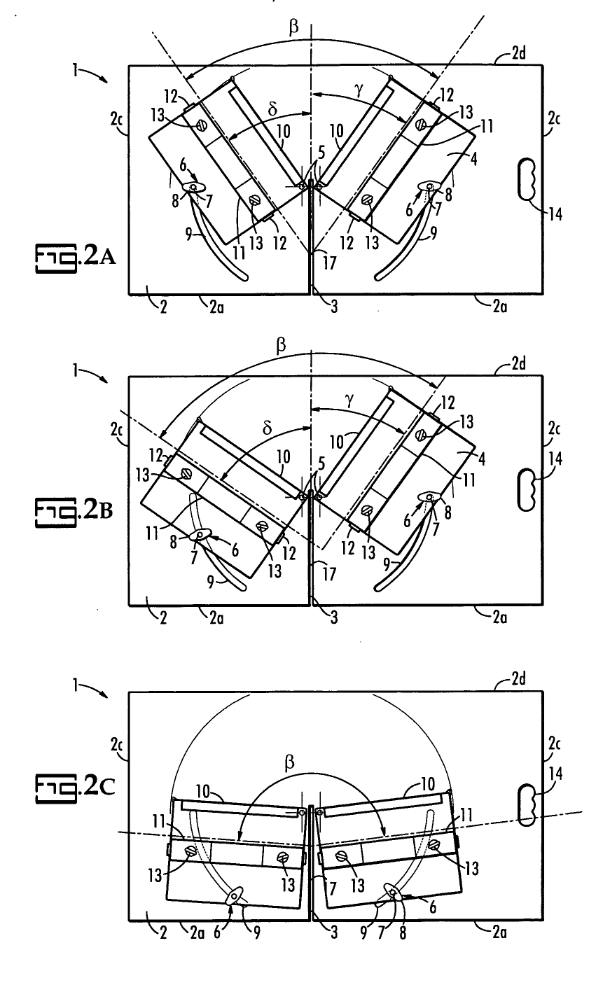

The angle between walls is then determined as known in the art such as by a protractor, variable protractor, etc. Each guide plate is rotated about the pivot until the guide angle, β, between either the fixed fences or the variable fences is the same as that between the walls. By definition the guide angle, β, is the sum of the angle of the first guide, γ, and the angle of the second slide, δ. It is preferred that the angle of the first guide, γ, and the angle of the second slide, δ, be the same such that the intersection of the projections of the angle are at the blade kerf as shown at 17 in FIG. 2a. If the angles are not the same the intersection is not at the kerf as shown at 18 in FIG. 2b. This may be preferable in some instances and will still provide an accurate cut. The scale, 15, and indicator, 16, are useful to indicate symmetry. FIG. 2C illustrates a configuration with the fences of each guide plate approaching parallel. In one embodiment the fixed fences may be removable thereby allowing the adjustable fences to be used as a variable angle fence which provides an additional use, feature and advantage of the present invention.

With the adjustable miter box adjusted as described, the adjustable miter box is placed in position such that the cutting path of the saw blade aligns with the kerf as would be realized. A piece of stock is place in contact with the fixed fence and adjustable fence, as illustrated in FIG. 1, and overlapping the projection of the blade kerf. The blade then cuts the stock as would be readily apparent to one of skill in the art.

It is preferred that, during use, the base plate be secured to the table of the radial arm or miter saw with clamps or the like as would be realized to one of skill in the art. Securing the base plate to the table allows the adjustable miter box to function in concert with the saw thereby requiring no alteration and taking advantage of all safety and convenience features associated with radial arm and miter saws.

In another embodiment the base plate represents the table of the miter or radial arm saw with the guide plates mounted directly to the table. In this instance the pivots would preferably be a pin and the table would comprise pin receiving voids symmetrically placed on either side of the typical blade relief slot of the saw which would be structurally analogous to the blade kerf.

The materials of construction are not limited herein. Preferred materials of construction include wood, aluminum, steel, and composites. Aluminum is a particularly preferred material of construction for the base due to the high strength to weight ratio, low cost, and ease of machining.

The invention has been described with particular emphasis on the preferred embodiments. It would be apparent that other embodiments and alterations could be employed without departing from the scope of the invention which is set forth in the claims appended hereto.

Claimed is:

1. An adjustable miter box comprising:
a planar base plate comprising:
a rear edge and a front edge;
a blade kerf extending from said rear edge toward said front edge;
a first guide plate pivotally attached to said base plate; and
a second guide plate pivotally attached to said base plate wherein said blade kerf extends between said first guide plate and said second guide plate; and
each of said first guide plate and said second guide plate comprises:
a fixed fence and an adjustable fence wherein said adjustable fence is slidably attached to said guide plate such that the distance between said fixed fence and said adjustable fence is adjustable and wherein said fixed fence and said adjustable fence remain parallel.

2. The adjustable miter box of claim 1 wherein at least one said guide plate comprises an engageable arcuate lock mechanism.

3. The adjustable miter box of claim 1 wherein said blade kerf is perpendicular to said rear edge.

4. The adjustable miter box of claim 1 wherein at least one said adjustable fence comprises at least one guide to maintain said adjustable fence in parallel relationship with said fixed fence.

5. The adjustable miter box of claim 1 wherein at least one said adjustable fence comprises a lock to reversibly fix said adjustable fence a predetermined distance from said fixed fence.

6. The adjustable miter box of claim 1 further comprising an angular scale indicting the angle between at least one said fixed fence and said kerf.

7. A method for cutting stock comprising:
placing stock on a guide plate at a first angle relative to said guide plate and in contact with a fixed fence on said guide plate;
sliding an adjustable slide plate on said guide plate into position to maintain said stock at said angle;
pivoting said guide plate to a second angle relative to a blade kerf; and
moving a blade into said blade kerf whereby said stock is cut by said blade.

8. The method for cutting stock of claim 7 further comprising:
placing second stock on a second guide plate at said first angle relative to said second guide plate and in contact with a second fixed fence on said second guide plate;
sliding a second adjustable slide plate on said second guide plate into position to maintain said second stock at said first angle;
pivoting said second guide plate to a third angle relative to said blade kerf;
moving said blade into said blade kerf whereby said second stock is cut.

9. The method for cutting stock of claim 8 wherein said second angle and said third angle are the same.

10. The method for cutting stock of claim 7 wherein at least one said guide plate comprises an engageable arcuate lock mechanism.

11. The method for cutting stock of claim 7 wherein said blade kerf is perpendicular to said rear edge.

12. The method for cutting stock of claim 7 wherein at least one said adjustable fence comprises at least one guide to maintain said adjustable fence in parallel relationship with said fixed fence.

13. The method for cutting stock of claim 7 wherein at least one said adjustable fence comprises a lock to reversibly fix said adjustable fence a predetermined distance from said fixed fence.

14. The method for cutting stock of claim 7 further comprising an angular scale indicting the angle between at least one said fixed fence and said kerf.

15. An adjustable miter box comprising:
a base plate comprising a blade kerf;
a first guide plate pivotally attached to said base plate; and
a second guide plate pivotally attached to said base plate wherein said blade kerf extends between said first guide plate and said second guide plate; and
each of said first guide plate and said second guide plate comprises a fixed fence and an adjustable fence wherein said adjustable fence is slidably attached to said guide plate such that the distance between said fixed fence and said adjustable fence is adjustable and wherein said fixed fence and said adjustable fence remain parallel.

16. The adjustable miter box of claim 15 wherein at least one said guide plate comprises an engageable arcuate lock mechanism.

17. The adjustable miter box of claim 15 wherein at least one said adjustable fence comprises at least one guide to maintain said adjustable fence in parallel relationship with said fixed fence.

18. The adjustable miter box of claim 15 wherein at least one said adjustable fence comprises a lock to reversibly fix said adjustable fence a predetermined distance from said fixed fence.

19. The adjustable miter box of claim 15 further comprising an angular scale indicting the angle between at least one said fixed fence and said kerf.
